(19) United States
(12) Patent Application Publication
(10) Pub. No.: US 2002/0043218 A1
(43) Pub. Date: Apr. 18, 2002

(54) Ice pack and therapeutic covering for horses

(76) Inventor: Tina Butler, Dunkirk, MD (US)

Correspondence Address: NIXON & VANDERHYE P.C., 8th Floor, 1100 North Glebe Road, Arlington, VA, 22201, US

(21) Appl. No.: 09/896,112

(22) Filed: Jul. 2, 2001

Related U.S. Application Data
(63) Continuation-in-part of application No. 29/130,916, filed on Oct. 12, 2000.

(51) Int. Cl. A01K 27/00

(52) U.S. Cl. 119/792

(57) ABSTRACT

An ice pack for an animal such as horse includes a main panel sized to fit over a horse's back and sides. The main panel includes side sections extending from opposite sides of a center section. A plurality of ice pockets are attached to each of the side sections of the main panel and preferably also to the center section of the main panel. The ice pockets contain ice to facilitate the application of ice to a horse. A strap secured to the main panel secures the main panel to the horse.

### CROSS-REFERENCES TO RELATED APPLICATIONS

This application is a continuation-in-part (CIP) of U.S. Design patent application Ser. No. 29/130,916, filed Oct. 12, 2000, pending, the entire contents of which is hereby incorporated by reference in this application.

### STATEMENT REGARDING FEDERALLY SPONSORED RESEARCH OR DEVELOPMENT

(NOT APPLICABLE)

### BACKGROUND OF THE INVENTION

The present invention relates to physical therapy for animals and, more particularly, to an ice pack or therapeutic covering for a horse.

Like humans, when horses work, their muscles become tired and sore particularly over extended work periods or as a horse ages. In human physiology, icing sore muscles serves to reduce pain and inflammation. Horse muscles react similarly such that regular icing of particular muscles after a horse performs its work helps the horse to perform at a top level for a lengthened period of time over the horse's working life. Ice further helps the horse's muscles to stay healthy and in the event of injury, shortens recovery time. Ice advantageously also helps the horse to regain range of motion and controls muscle spasms.

Previously, in order to apply ice to a horse's muscles, ice containers and the like had to be positioned adjacent a horse's muscles. Ice wraps and other devices have been used to secure ice against a horse's legs, but such wraps necessarily neglect the horse's important muscles through its torso. Moreover, positioning of the ice becomes a problem when an inexperienced trainer is not aware of appropriate locations to apply the ice.

### SUMMARY OF THE INVENTION

According to the present invention, an ice pack for animals such as a horse can be readily secured to a horse and includes particularly positioned ice pockets that receive ice and maintain the ice against the horse's muscles in appropriate locations. The ice pack, according to the invention, is readily transferable from horse to horse, and ice can be readily inserted into the ice pockets.

In an exemplary embodiment of the invention, an ice pack for a horse includes a main panel sized to fit over a horse's back and sides. The main panel includes side sections extending from opposite sides of a center section. A strap, secured to the main panel, secures the main panel to the horse. A plurality of ice pockets are attached to each of the side sections of the main panel. Additionally, at least one ice pocket may be attached to the center section of the main panel. Preferably, a plurality of ice pockets are positioned relative to the main panel to rest adjacent particular muscles of the horse. Such muscles may include rhomboids, latissimus dorsi, longissimus dorsi, intercostal, serratus and thoracis muscles.

The strap may include a first side secured to one of the side sections and a second side secured to the other of the side sections, the first and second sides of the straps being sized to meet underneath the horse. The strap may further include a hook and loop fastener on the first and second sides, respectively.

The main panel is preferably formed of a fabric material such as denim. The ice pockets are preferably sewed to the main panel. The center section may be shorter in length than the side sections, thereby defining a recessed area between the side sections that is sized to receive the horse's neck. In this context, the side sections each include a tapered transition area extending from the recessed area adjacent the center section to a longest portion of the side sections, respectively.

In another exemplary embodiment of the invention, a therapeutic covering for a horse includes a main panel formed of a fabric material that is sized to fit over the horse's back and sides. A plurality of ice-containing components are secured to the main panel, and the covering includes structure for securing the main panel to the horse.

### BRIEF DESCRIPTION OF THE DRAWINGS

These and other aspects and advantages of the invention will be described in detail with reference to the accompanying drawings, in which:

FIG. 1 is a plan view of the horse ice pack according to the present invention;

FIG. 2 is an underside view of the horse ice pack; and

FIG. 3 is a perspective view of a horse wearing the horse ice pack.

### DETAILED DESCRIPTION OF PREFERRED EMBODIMENTS

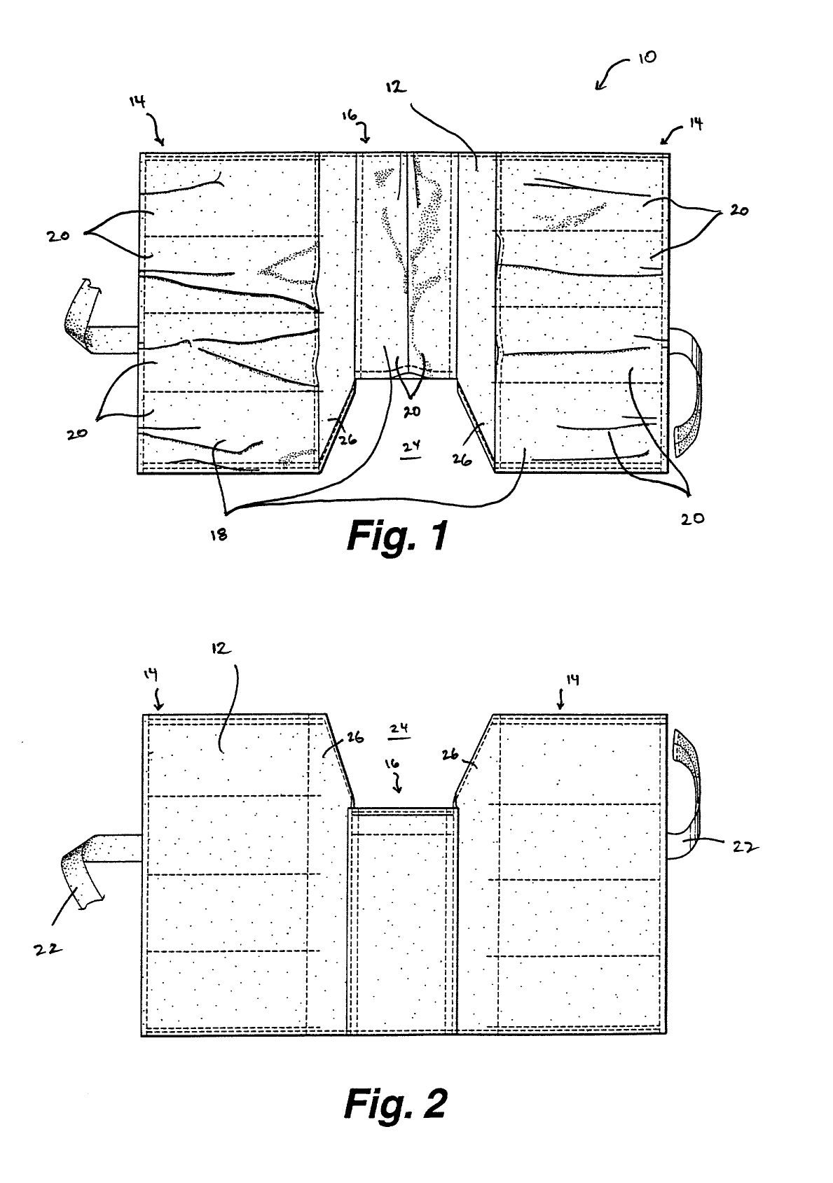

With reference to the Figures, the horse ice pack 10, according to the present invention, includes a main panel 12 of a fabric material that is sized to fit over a horse's back and sides. The fabric material can be any suitable material for the described purpose. Examples of suitable materials include twill, cotton/polyester blend, nylon, denim, etc. The main panel includes side sections 14 that extend from opposite sides of a center section 16. First, second and third sub-panels 18 are secured, preferably by sewing, to the main panel 12 and are used to form a plurality of ice pockets 20. As shown in FIG. 1, the sub-panels 18 are generally laid over the side sections 14 and the center section 16 of the main panel 12. The sub-panels 18 are then secured to the main panel 12, and the ice pockets 20 are formed. As noted, the ice pockets 20 are preferably formed via sewing, although other securing means may be appreciated by those of ordinary skill in the art. For example, assuming the suitability of the fabric material, the subpanels 18 and the ice pockets 20 may be secured and formed via ultrasonic welding. Adhesives or rivet connectors or the like may also be used. Additionally, the ice pockets 20 may be oriented differently than illustrated provided the general location of the ice in the ice pockets 20 remains the same, and the invention is not meant to be limited to the illustrated orientations.

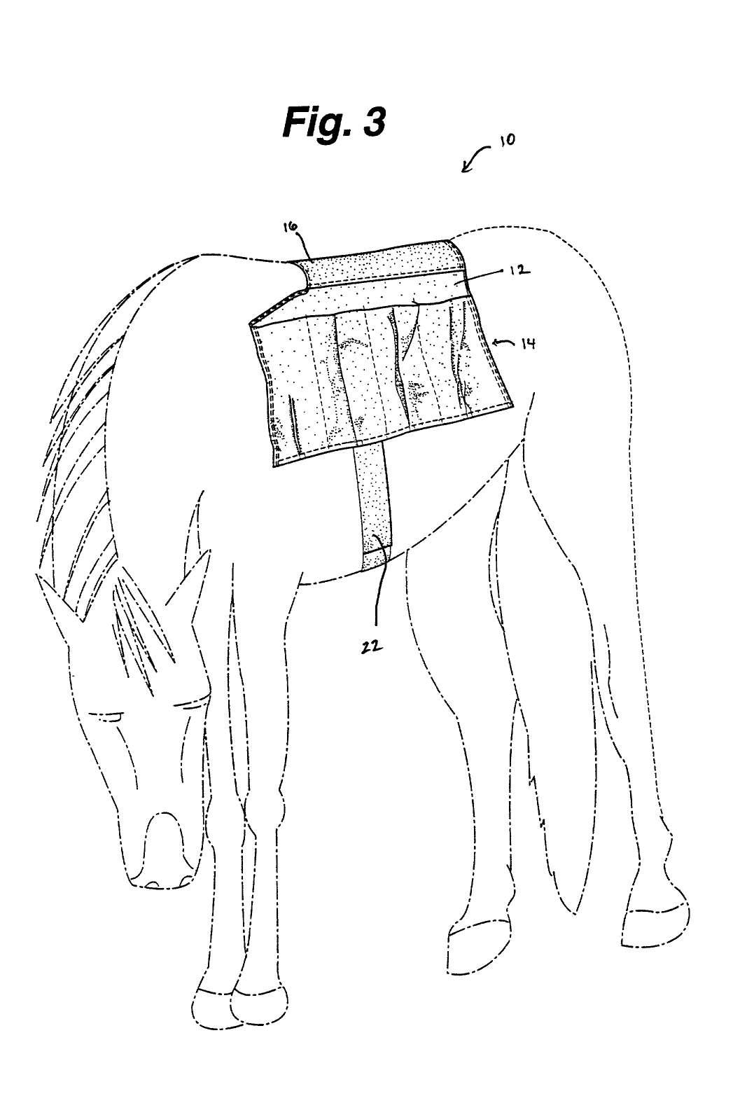

A strap 22 includes first and second sides secured respectively to each of the side sections 14 preferably by sewing. As shown in FIG. 3, the first and second sides of the strap 22 are sized to meet underneath the horse. This strap 22 includes connecting structure such as a hook and loop fastener or the like to secure the first and second sides of the strap 22. Of course, any suitable securing structure can be used and the invention is not necessarily meant to be limited to the described example. For example, the strap may include a belt buckle type attachment, a mortis and tendon attachment, clips, pins or any suitable structure that can secure the first and second sides of the strap 22 underneath the horse.

As shown in the drawings, the center section 16 is generally shorter in length than the side sections 14, thereby defining a recessed area 24 between the side sections 14. The recessed area 24, as shown in FIG. 3, accommodates the top portion of the horse's neck. In this context, each of the side sections 14 includes a tapered transition area 26 that extends from the recessed area 24 adjacent the center section 16 to a longest portion of the side sections 14, respectively.

The plurality of ice pockets 20 are particularly positioned relative to the main panel 12 to rest adjacent particular muscles of the horse. In particular, it is desirable to apply ice to the horse's rhomboids, latissimus dorsi, longissimus dorsi, intercostal, serratus and thoracis muscles. Generally, an ice application to a horse should not exceed twenty minutes within a two hour time period. The ice itself may be contained within an individual ice pack or a plastic bag or the like to contain the melting ice. Loose ice or uncontained ice blocks could also be inserted in the pockets of the ice pack according to the invention, where the melting ice will simply run off the horse.

With the structure of the present invention, ice can be easily and appropriately applied to a horse to serve as a therapeutic covering to facilitate healing of sore muscles while decreasing swelling, scar formation, pain, bruising, recovery time, pulse and blood pressure and while increasing circulation and lymphatic return. The portable pack can be readily transferred from horse to horse and folds into a compact, easily transported package.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An ice pack for a horse comprising:
a main panel sized to fit over a horse's back and sides, the main panel including side sections extending from opposite sides of a center section;
a strap secured to the main panel that secures the main panel to the horse; and
a plurality of ice pockets attached to each of the side sections of the main panel.

2. An ice pack for a horse according to claim 1, further comprising at least one ice pocket attached to the center section of the main panel.

3. An ice pack for a horse according to claim 2, wherein the plurality of ice pockets are positioned relative to the main panel to rest adjacent particular muscles of the horse.

4. An ice pack for a horse according to claim 3, wherein the plurality of ice pockets are positioned relative to the main panel to rest adjacent the horse's rhomboids, latissimus dorsi, longissimus dorsi, intercostal, serratus and thoracis muscles.

5. An ice pack for a horse according to claim 1, wherein the strap comprises a first side secured to one of the side sections and a second side secured to the other of the side sections, the first and second sides of the strap being sized to meet underneath the horse.

6. An ice pack for a horse according to claim 5, wherein the strap further comprises a hook and loop fastener on the first and second sides, respectively.

7. An ice pack for a horse according to claim 1, wherein the main panel is formed of a fabric material.

8. An ice pack for a horse according to claim 7, wherein the fabric material is twill.

9. An ice pack for a horse according to claim 7, wherein the ice pockets are sewed to the main panel.

10. An ice pack for a horse according to claim 1, wherein the center section is shorter in length than the side sections, thereby defining a recessed area between the side sections that is sized to receive the horse's neck.

11. An ice pack for a horse according to claim 10, wherein the side sections each comprise a tapered transition area extending from the recessed area adjacent the center section to a longest portion of the side sections, respectively.

12. A therapeutic covering for a horse comprising:
a main panel formed of a fabric material, the main panel being sized to fit over a horse's back and sides;
a plurality of individual ice-containing components secured to the main panel; and
means for securing the main panel to the horse.

13. A therapeutic covering for a horse according to claim 12, wherein the main panel comprises a center section and two side sections extending from the center section.

14. A therapeutic covering for a horse according to claim 13, wherein the individual ice-containing components comprise ice pockets secured to the center section and the side sections of the main panel.

15. A therapeutic covering for a horse according to claim 14, wherein the ice pockets are sewed to the main panel.

16. A therapeutic covering for a horse according to claim 12, wherein the securing means comprises a pair of straps that extend from the side sections, respectively.

17. A therapeutic covering for a horse according to claim 15, wherein the pair of straps are releasably securable to each other.

18. A therapeutic covering for a horse according to claim 17, wherein the pair of straps are releasably securable to each other via a hook and loop fastener.
